(19) United States
(12) Patent Application Publication
(10) Pub. No.: US 2025/0027798 A1
(43) Pub. Date: Jan. 23, 2025

(54) MAGNETIC-INDUCTIVE FLOW METER

(71) Applicant: Endress+Hauser Flowtec AG, Reinach (CH)

(72) Inventors: Florent Tschambser, Hesingue (FR); Tulio Paiva Galvao, Schopfheim (DE); Simon Triebenbacher, Basel (CH); Daniel Kuttler, Basel (CH)

(21) Appl. No.: 18/715,496

(22) PCT Filed: Nov. 22, 2022
(86) PCT No.: PCT/EP2022/082697

§ 371 Date: May 31, 2024

(30) Foreign Application Priority Data
Dec. 1, 2021 (DE) 10 2021 131 693.6

(51) Int. Cl. G01F 1/60; G01F 1/58; G01F 25/10

(52) U.S. Cl. CPC G01F 1/60; G01F 1/588; G01F 25/10

(57) ABSTRACT

A magnetic-inductive flow meter for determining a flow velocity-dependent measurement variable of a flowable medium includes: a device for generating a magnetic field and a device for tapping a measurement voltage induced in the flowable medium; an operating circuit configured such that, by an electrical operating signal having a variable coil voltage and a variable coil current, electrical power is feed into the magnetic field device, wherein the operating signal has a temporally variable coil voltage curve, which is divided into time intervals, each having a first time subinterval in which a first coil voltage is applied to the magnetic field device; a control circuit configured to control at least the first coil voltage such that a deviation of a control function from a predefined control target value is minimal; and a diagnostic circuit for monitoring at least one diagnostic value.

The invention relates to a magnetic-inductive flow measurement device, in particular a magnetic-inductive flow meter device and/or a magnetic-inductive flow measuring probe.

Magnetic-inductive flow meters are used for determining the flow rate and the volumetric flow of a flowing medium in a pipeline. A distinction is made here between in-line magnetic-inductive flow meters and magnetic-inductive flow measuring probes, which are inserted into a lateral opening of a pipeline. A magnetic-inductive flow meter has a device for generating a magnetic field, which produces a magnetic field perpendicularly to the flow direction of the flowing medium. Single coils are typically used for this purpose. In order to realize a predominantly homogeneous magnetic field, pole shoes are additionally formed and attached such that the magnetic field lines run over the entire tube cross-section substantially perpendicularly to the transverse axis or in parallel to the vertical axis of the measuring tube. In addition, a magnetic-inductive flow meter has a measuring tube on which the device for generating the magnetic field is arranged. A measurement electrode pair attached to the lateral surface of the measuring tube taps an electrical measurement voltage or potential difference which is applied perpendicularly to the direction of flow and to the magnetic field and occurs when a conductive medium flows in the direction of flow when the magnetic field is applied. Since, according to Faraday's law of induction, the tapped measurement voltage depends on the velocity of the flowing medium, the flow rate and, with the inclusion of a known tube cross-section, the volumetric flow can be determined from the induced measurement voltage.

In contrast to a magnetic-inductive flow meter, which comprises a measuring tube for conducting the medium with an attached device for generating a magnetic field penetrating the measuring tube and with measuring electrodes, magnetic-inductive flow measuring probes are inserted with their usually circular cylindrical housings into a lateral opening of a tube line and fixed in a fluid-tight manner. A special measuring tube is no longer necessary. The measuring electrode arrangement and coil arrangement, mentioned in the introduction, on the lateral surface of the measuring tube are omitted and are replaced by a device for generating a magnetic field, which device is arranged in the interior of the housing and in direct proximity to the measuring electrodes and is designed such that an axis of symmetry of the magnetic field lines of the produced magnetic field perpendicularly intersects the front face or the face between the measuring electrodes. In the prior art, there is already a plurality of different magnetic-inductive flow measuring probes.

Magnetic-inductive flow meters are often used in process and automation engineering for fluids, starting from an electrical conductivity of approximately 5 ρS/cm. Corresponding flow measurement devices are sold by the applicant in a wide variety of embodiments for various fields of application, for example under the name PROMAG or MAGPHANT.

There is a plurality of different methods for controlling the operating signal applied to the coil arrangement. Generally, they aim at generating a magnetic field with a magnetic induction that is as constant as possible over an entire measurement phase. WO 2014/001026 A1, for example, discloses a controller in which a voltage signal applied to the coil arrangement is controlled in such a way that a coil current flowing through the coil arrangement reaches and maintains a coil current setpoint value in a defined measurement phase. The coil current flowing through the coil arrangement produces a magnetic field with a magnetic induction that depends on the coil current.

DE 10 2015 116 771 B4 also discloses a method for setting a constant magnetic field strength of a magnetic field in a magnetic-inductive flow meter. In this case, a constant setpoint current is specified for a current controller.

It is basically assumed that by establishing a fixed coil current setpoint value for all time intervals, the magnetic induction of the produced magnetic field also assumes a setpoint value in a reproducible manner. An advantage of such a control is that the control does not require measuring the magnetic induction. However, it has been found that, due to temperature changes and magnetic interference fields, the magnetic field cannot be reproduced solely by adjustment to a fixed coil current setpoint value. As a result, the calibration values assumed for determining the flow-rate-dependent measured variable for magnetic induction differs from the currently present magnetic induction in the measuring tube. Depending on the disturbance variable, this can lead to deviations of up to 20% when determining the flow-rate-dependent measured variable.

The object of the invention is to provide a magnetic-inductive flow meter with a more robust magnetic field and corresponding diagnostics.

The object is achieved by the magnetic-inductive flow meter according to claim 1 and the method according to claim 27.

The magnetic-inductive flow meter according to the invention for detecting a flow rate-dependent measurement variable of a flowable medium, comprising:
a device for generating a magnetic field, in particular comprising a coil arrangement;
a device for tapping off a measurement voltage induced in the flowable medium, in particular comprising at least two preferably diametrically arranged measurement electrodes;
an operating circuit which is configured to feed electrical power into the device for generating the magnetic field by means of an electrical operating signal having a variable (coil) voltage and a variable (coil) current,
   wherein the operating signal has a (coil) voltage curve that varies over time and is divided into time intervals,
   wherein the time intervals each have a first time subinterval in which a first (coil) voltage is applied to the device for generating the magnetic field over the, in particular totality, of the first time subinterval, in particular at a constant level;
a control circuit,
   wherein the control circuit is configured to control at least the first (coil) voltage in such a manner that a deviation of a control function from a predetermined control setpoint, particularly comprising a quantity proportional to a magnetic flux, is minimized; and
a diagnostic circuit for monitoring at least one diagnostic value.

Magnetic-inductive flow meters with this type of control circuit are more resistant to external interference fields. The control circuit according to the invention is particularly advantageous for use in magnetic-inductive flow meters supplied via an electrochemical storage unit. These are usually operated with a significantly lower (coil) current or a significantly lower (coil) voltage than conventional magnetic-inductive flow meters supplied via a (coil) power supply. This means that the field-conducting components do not go into magnetic saturation during use. As a result, in addition to a particularly increased sensitivity to external interference fields, they also have an extended settling time during startup, wherein the settling time describes the period to be waited after the flow measurement device has been switched on until the device for generating the magnetic field is warmed up and in which the magnetic induction continuously settles toward the setpoint value. Magnetic-inductive flow meters with the controller circuit according to the invention moreover have a significantly lower temperature coefficient of the magnetic field, wherein the temperature coefficient describes the deviation of the magnetic field per temperature change.

The control target value determined and provided at the factory or during startup can be determined in an adjustment method or by computer simulation. The control target value further comprises a variable that is proportional to the magnetic flux. This means that the target value comprises the unit of one of the magnetic fluxes. The magnetic flux of a coil arrangement depends on the one hand on the self-induction L of the coil and a quadratic contribution of the (coil) current currently flowing through the coil arrangement, and on the other hand on the magnetic flux generated by eddy currents occurring in the metallic carrier tube and the housing. When attaching or bringing an external magnet closer to the magnetic-inductive flow meter, said magnet also contributes to the magnetic flux in the measuring tube.

For example, the diagnostic circuit can be configured to monitor the symmetry of the (coil) current of different line intervals or time subintervals.

Advantageous embodiments of the invention are the subject matter of the dependent claims.

One embodiment provides that the time intervals each have a second time subinterval in which a second (coil) voltage, in particular a constant second voltage, is applied to the device for generating the magnetic field over the, in particular totality, second time subinterval,
wherein the second (coil) voltage is greater than the first (coil) voltage,
wherein the duration of the second time subinterval and the first (coil) voltage are each a changing and controllable variable,
wherein the control function depends on a product of the duration of the second time subinterval and a function dependent on the first (coil) voltage.

The advantage of this embodiment is that the measurement intervals, in which the coil current has settled and assumes a coil current value which substantially no longer changes over time, start much earlier as a result. Another advantage of the design is that it provides a control system that ensures a robust magnetic field and at the same time reacts very quickly to the influences of external magnetic fields.

One embodiment provides that an amount of a quotient of the first (coil) voltage and the second (coil) voltage is constant over the (coil) voltage curve,
wherein the function dependent on the first (coil) voltage is inversely proportional to the duration of the second time subinterval.

One embodiment provides that an amount of the second (coil) voltage is constant over the time intervals.

One embodiment provides that the (coil) current assumes a maximum (coil) current value in each of the time intervals, particularly in the first time subinterval,
wherein the condition is fulfilled that one of a quotient of the maximum (coil) current value and a (coil) current value determined during the first time subinterval is constant over the operating signal.

By determining the quotient of the first (coil) voltage and the second (coil) voltage, a simplified control results. A reduction in sensitivity to interference fields and temperature influences was possible to achieve by determining, as an operating signal parameter, the function dependent on the product of the duration of the second time subinterval and on the first (coil) voltage. A magnetic-inductive flow measurement device having particularly high insensitivity and fast reaction time was possible to achieve in particular by controlling the variable and controllable duration of the second time subinterval and of the first (coil) voltage or of the function dependent on the first (coil) voltage such that the product between the two parameters assumes a control setpoint value. In addition, continuous monitoring of the apparent self-induction of the magnetic-inductive flow measurement device is not necessary. It has been found that as a result of the embodiment according to the invention, in which the function dependent on the product of the duration of the second time subinterval and on the first (coil) voltage is kept constant, the function dependent on the self-induction value of the apparent self-induction and on the coil current value of the (coil) current or its product remains constant as well. Since the quotient of the first (coil) voltage and second (coil) voltage is constant, the function dependent on the first (coil) voltage is to be equated with a function dependent on the second (coil) voltage.

The controller circuit is configured to control the duration of the second time subinterval such that at a defined point in time, for example the beginning of the measurement interval in which the induced measurement voltage is determined, or in a time segment the difference between a test variable and a test setpoint value is minimal. The test variable can be a measured value of the (coil) current, a sum or an integral over a course of the (coil) current or a function dependent on the coil current. The test setpoint value for the different time subintervals can vary. Alternatively, the controller circuit can be designed and configured to control the duration of the second time subinterval such that a duration of the (coil) current settling after the beginning of the first time subinterval is minimal.

One embodiment provides that the (coil) current assumes a maximum (coil) current value in each of the time intervals, particularly in the first time subinterval,
wherein the function dependent on the first (coil) voltage also depends on the maximum (coil) current value.

One embodiment provides that the function dependent on the first (coil) voltage also depends on ln/), and is particularly proportional.

The second (coil) voltage can be selected to be constant or at a constant ratio to the first (coil) voltage. According to a preferred embodiment, however, the second (coil) voltage is a controllable variable. For example, the second (coil) voltage may be controlled such that the duration of the second time subinterval is as small as possible, i.e., the duration until the magnetic field assumes a steady state is as short as possible.

One embodiment provides that the control function depends on a product of the duration of a time subinterval and a function dependent on the first (coil) voltage,
wherein an amount of the (coil) current increases from a first (coil) current setpoint value to a second (coil) current setpoint value within the time subinterval.

One embodiment provides that the (coil) current assumes a maximum (coil) current value in each of the time intervals, particularly in the first time subinterval,
wherein the control function depends on a product of the duration of a third time subinterval and a function dependent on the first (coil) voltage,
wherein the third time subinterval is limited by a start of the second time subinterval and a point in time at which the (coil) current assumes the maximum (coil) current value.

In one embodiment, the sign of the (coil) voltage curve alternates in successive time intervals.

One embodiment provides that time intervals with a positive sign in the (coil) voltage curve have a first control setpoint and time intervals with a negative sign have a second control setpoint,
wherein the first control setpoint differs from the second control setpoint.

One embodiment provides that the control function depends on a product of a (coil) current value of the (coil) current during a measurement interval and an apparent self-inductance.

The apparent self-inductance of the magnetic-inductive flow measurement device can be determined, for example, from the gradient of the (coil) current around the coil current zero point. In this case, the electrical resistance is approximately zero, and thermal influences are negligibly small. In order to avoid eddy current effects, the apparent self-inductance can be determined in a time segment in which the coil current overshoots due to the switchover or change of the coil voltage and then decreases. During the overshoot, the temporal change in eddy currents is low. Alternatively, the apparent self-inductance can also be determined as a function of the time curve of the (coil) current and the coil voltage. A measuring circuit can be provided to determine the apparent self-inductance. The apparent self-inductance is made up of the self-inductance of the device for generating the magnetic field, the effects of eddy currents in the metal measuring tube and metal housing, if present in each case, and the effects of external magnetic fields.

In one embodiment, the magnetic-inductive flow meter comprises a device for detecting a (coil) current value,
wherein the device for detecting the (coil) current is configured to determine, in particular, the (coil) current value during a measurement interval,
wherein the diagnostic value comprises the (coil) current value.

As the (coil) current changes during the individual measuring intervals to ensure that the deviation of the control function from a control setpoint is minimal, it is advantageous if a current (coil) current value of the (coil) current is monitored. An increasing (coil) current can be used to derive a degradation of the device for generating the magnetic field or also the use of the magnetic-inductive flow measurement device temperatures below a lower temperature limit. A decreasing (coil) current can be used to determine the presence of an external magnetic field or the use of the electromagnetic flow measurement device temperatures above an upper temperature limit.

In one embodiment, the diagnostic circuit is configured to compare the (coil) current value with a factory-provided coil current value.

One embodiment provides that the (coil) current value corresponds to a maximum (coil) current value that is present during a time interval or during the first time subinterval and/or second time subinterval.

One embodiment provides that the diagnostic value comprises the first (coil) voltage or the second (coil) voltage or a variable dependent on the first (coil) voltage and/or the second (coil) voltage.

One embodiment provides that the diagnostic value comprises the duration of the second time subinterval or a variable dependent on the duration of the second time subinterval.

One embodiment provides that the diagnostic value comprises a quotient of the second (coil) voltage and the first (coil) voltage or the second (coil) voltage of a subsequent time interval.

One embodiment provides that the diagnostic value comprises a quotient of two preferably maximum (coil) current values determined during different measurement intervals.

One embodiment provides that the diagnostic value comprises a quotient of a (coil) current value determined during the measurement interval and a maximum (coil) current value determined during the time interval, particularly during the first time subinterval.

One embodiment provides that the diagnostic value comprises a rate of change of the (coil) current over several time intervals, particularly several measurement intervals.

It is particularly advantageous if the functionality of the device for generating the magnetic field is monitored over several time intervals. This makes it possible to determine the slow effects of ageing and to estimate the remaining service life.

One embodiment provides that the diagnostic value comprises a rate of change of the first (coil) voltage and/or the second (coil) voltage over several time intervals, particularly several measurement intervals.

In one embodiment, the diagnostic circuit is configured to take into account a coil resistance of the coil arrangement in order to monitor the ageing of the device for generating the magnetic field, particularly the coil arrangement.

The advantage of this design is that temperature influences on the control can be excluded.

One embodiment provides that the diagnostic value of the duration of the second time subinterval or a variable dependent thereon corresponds to a quotient of two durations, particularly successive second time subintervals.

One embodiment provides that the diagnostic value of the first (coil) voltage or a variable dependent thereon corresponds to a quotient of two, particularly successive, first (coil) voltages.

In one embodiment, the magnetic-inductive flow meter comprises a temperature sensor for detecting a first temperature value,
wherein the diagnostic circuit is configured to determine a second temperature value as a function of a (coil) current value and a known temperature coefficient,
wherein the diagnostic circuit is configured to compare the first temperature value with the second temperature value in order to monitor ageing of the device for generating the magnetic field.

If the temperature coefficient for the device for generating the magnetic field is known, a theoretical temperature can be determined on the basis of the (coil) current, and this can be compared with the temperature measured by means of a temperature sensor. If there is a discrepancy, the (coil) current change is due to an external magnetic field or ageing of the coil arrangement.

The method according to the invention for operating a magnetic-inductive flow meter for detecting a flow rate-dependent measurement variable of a flowable medium, wherein the magnetic-inductive flow meter comprises a device for generating a magnetic field and a device for tapping a measurement voltage in the medium, comprises the method steps: application of an electrical operating signal having a variable (coil) voltage and a variable (coil) current for feeding electrical power into the device for generating the magnetic field,
wherein the operating signal has a (coil) voltage curve that varies over time and is divided into time intervals,
wherein the time intervals each have a first time subinterval in which a first (coil) voltage is applied to the device for generating the magnetic field over the, in particular totality, of the first time subinterval, in particular constant voltage,
wherein the first (coil) voltage is controlled in such a manner that a deviation of a control function from the control setpoint is minimized, monitoring a diagnostic value.

One embodiment comprises the method step:
detecting a (coil) current value,
wherein the (coil) current value is determined during a measuring interval,
wherein the diagnostic value comprises the (coil) current value.

One embodiment comprises the method step:
comparing the (coil) current value with a factory-provided (coil) current value.

One embodiment provides that the (coil) current value corresponds to a maximum (coil) current value that is present during a time interval or during the first time subinterval and/or second time subinterval.

One embodiment provides that the diagnostic value comprises the first (coil) voltage or the second (coil) voltage or a variable dependent on the first (coil) voltage and/or the second (coil) voltage.

One embodiment provides that the diagnostic value comprises the duration of the second time subinterval or a variable dependent on the duration of the second time subinterval.

One embodiment provides that the diagnostic value comprises a quotient of the second (coil) voltage and the first (coil) voltage or the second (coil) voltage of a subsequent time interval.

One embodiment provides that the diagnostic value comprises a quotient of two (coil) current values, particularly maximum values, determined during different measurement intervals.

One embodiment provides that the diagnostic value comprises a quotient of a (coil) current value determined during the measurement interval and a maximum (coil) current value determined during the time interval, particularly during the first time subinterval.

One embodiment provides that the diagnostic value comprises a rate of change of the (coil) current over several time intervals, particularly several measurement intervals.

One embodiment provides that the diagnostic value comprises a rate of change of the first (coil) voltage and/or the second (coil) voltage over several time intervals, particularly several measurement intervals.

One embodiment comprises the method step:
considering a coil resistance of the coil arrangement for monitoring ageing of the coil arrangement.

One embodiment provides that the diagnostic value of the duration of the second time subinterval or a variable dependent thereon corresponds to a quotient of two durations, particularly successive second time subintervals.

One embodiment provides that the diagnostic value of the first (coil) voltage or a variable dependent thereon corresponds to a quotient of two, particularly successive, first (coil) voltages.

One embodiment comprises the method steps of:
determining a first temperature value by means of a temperature sensor,
detecting a second temperature value as a function of a (coil) current value and a known temperature coefficient,
wherein the diagnostic circuit is configured to compare the first temperature value with the second temperature value in order to monitor ageing of the device for generating the magnetic field.

One embodiment provides that the respective absolute value of the (coil) current values of the (coil) current of different measuring intervals is a variable quantity.

In one embodiment, 1≤t_{hold}≤2000 ms, in particular 5≤t_{hold}≤1000 ms.

In one embodiment, 0.1≤tₛₕₒₜ≤500 ms, in particular 0.1≤_{hold}≤300 ms.

In one embodiment, 1≤Uₛₕₒₜ≤230 V, in particular 3.6≤Uₛₕₒₜ≤60 V.

In one embodiment, 0.1≤U_{hold}<23 V, in particular 0.5≤U_{hold}≤20 V.

In one embodiment, 5≤I≤2000 mA, in particular 10≤I≤500 mA.

One embodiment provides for the control setpoint value to assume a value between 0.01 and 10 Wb.

In one embodiment, the first time subinterval follows the second time subinterval in the (coil) voltage curve.

One embodiment provides for coil currents of different measurement intervals to be changing variables or coil current values of different measurement intervals to differ from each other.

One embodiment provides for the magnetic-inductive flow meter to be designed as a magnetic-inductive flowmeter, comprising a measuring tube for conducting the flowable medium.

One embodiment provides for the magnetic-inductive flow meter to be designed as a magnetic-inductive flow measuring probe to be introduced into a lateral opening of a pipeline, comprising a housing to be supplied with the medium.

The invention is explained in greater detail with reference to the following figures. In the figures:

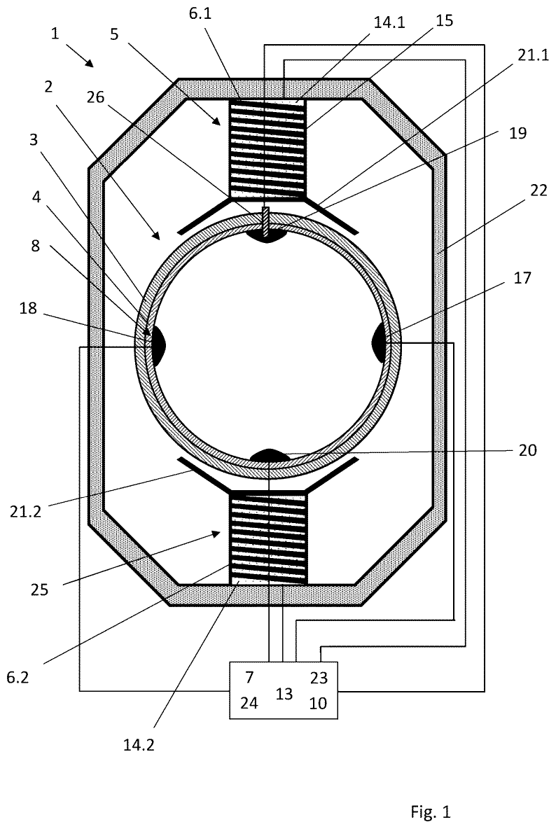

FIG. 1: shows an embodiment of a magnetic-inductive flow meter according to the invention;

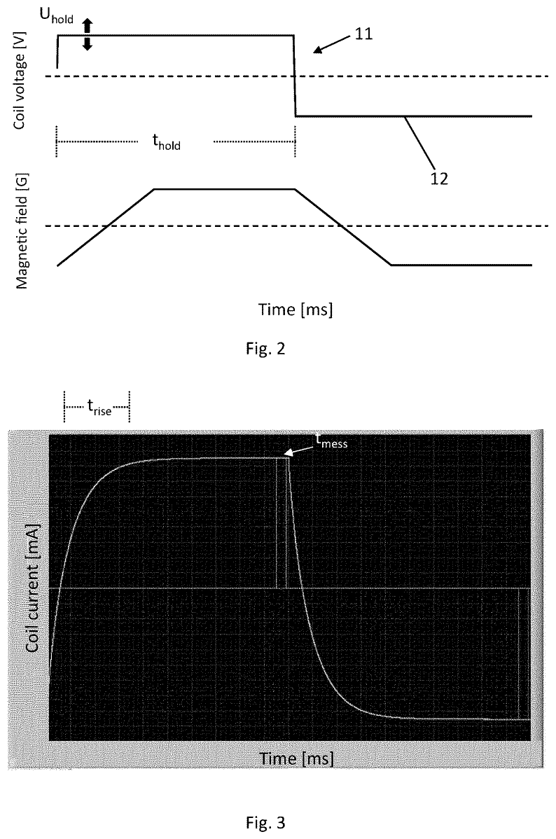

FIG. 2: shows a first embodiment of the curve of the (coil) voltage and the correspondingly produced magnetic field through the coil arrangement;

FIG. 3: shows a first embodiment of the curve of the current flowing through the coil arrangement;

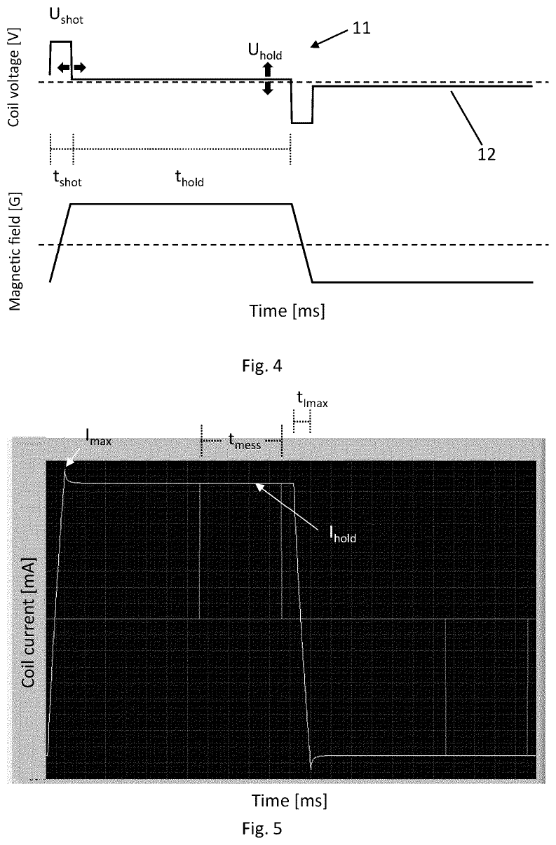

FIG. 4: shows a second embodiment of the course of the (coil) voltage and the corresponding magnetic field generated by the coil arrangement;

FIG. 5: shows a second embodiment of the curve of the (coil) current flowing through the coil arrangement;

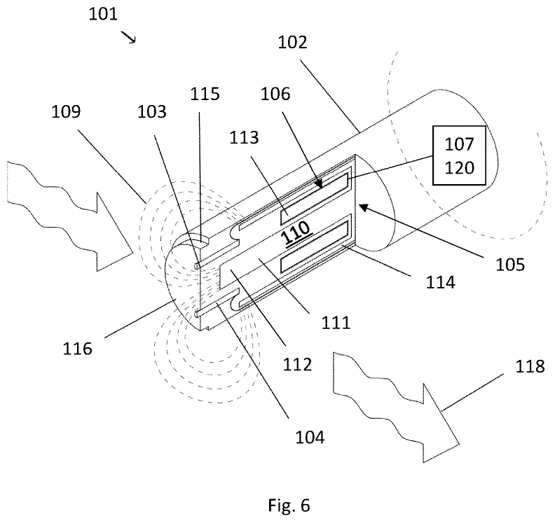

FIG. 6: shows a perspective view of a partially sectioned embodiment of a magnetic-inductive flow measuring probe according to the invention; and

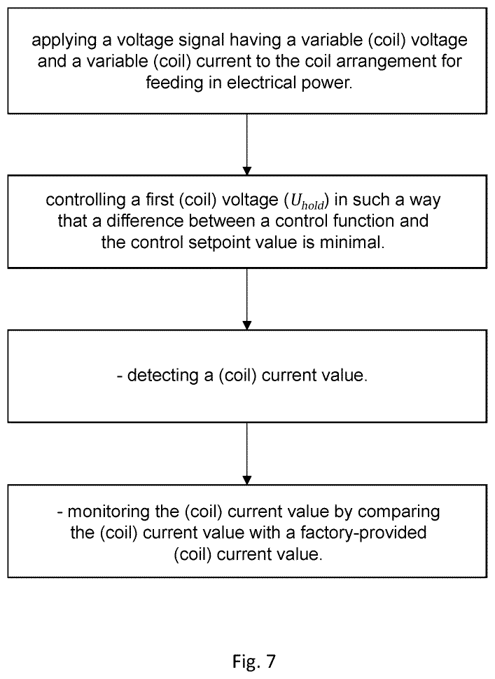

FIG. 7: shows a representation of one embodiment of the method sequence.

FIG. 1 shows a cross-section of an embodiment of the magnetic-inductive flow meter 1 according to the invention. The structure and measuring principle of a magnetic-inductive flow meter 1 are known in principle. A flowable medium having an electrical conductivity is conducted through a measuring tube 2. The measuring tube 2 comprises a carrier tube 3, which is usually formed of, or at least comprises, steel, ceramic, plastic or glass. A device 5 for generating a magnetic field is arranged on the carrier tube 3 such that the magnetic field lines are oriented substantially perpendicularly to a longitudinal direction defined by the measuring tube axis. The device 5 for generating the magnetic field comprises a coil arrangement consisting of at least one saddle coil or at least one coil 6. Normally, magnetic-inductive flow meters have two diametrically arranged coils 6. A coil core 14 usually extends through a receptacle 15 of the coil 6. The receptacle 15 is understood to mean the volume limited by the coil wire forming the coil 6. The receptacle 15 of the coil 6 can thus be formed by a coil holder or by the imaginary enclosed volume. The latter occurs when the coil wire of the coil 6 is wound directly around the coil core 14. The coil core 14 is formed from a magnetically conductive, in particular soft magnetic material. The device 5 for generating the magnetic field normally also comprises a pole shoe 21 which is arranged at one end of the coil core 14. The pole shoe 21 can be a separate component or can be monolithically connected to the coil core 14. In the embodiment shown in FIG. 1, two diametrically arranged coils 6.1, 6.2 each have a coil core 14.1, 14.2 and a pole shoe 21.1, 21.2. The two coil cores 14.1, 14.2 are connected to one another via a field return 22. The field return 22 connects the sides of the coil cores 14.1, 14.2 facing away from one another in each case. However, magnetic-inductive flow meters having exactly one coil having a coil core or a saddle coil and without a field return are also known. The device 5 for generating a magnetic field, in particular the coil 6 is connected to an operating circuit 7 which operates the coil 6 with an operating signal 11. The operating signal 11 can be a (coil) voltage with a time-varying voltage curve and is characterized by operating signal parameters, wherein at least one of the operating signal parameters is controllable. The magnetic field built up by the device 5 for generating the magnetic field is produced by a (coil) voltage of alternating polarity clocked by means of an operating circuit 7. This ensures a stable zero point and makes the measurement insensitive to influences due to electrochemical disturbances. The two coils 6.1, 6.2 can be connected separately to the operating circuit 7 or connected in series or parallel to one another.

When the magnetic field is applied, a flow-dependent potential distribution results in the measuring tube 2, which potential distribution can be detected, for example, in the form of an induced measurement voltage. A device 8 for tapping off the induced measurement voltage is arranged on the measuring tube 2. In the embodiment shown, the device 8 for tapping off the induced measurement voltage is formed by two oppositely arranged measurement electrodes 17, 18 to form a galvanic contact with the medium. However, what is also known are magnetic-inductive flow meters which comprise measurement electrodes arranged on the outer wall of the carrier tube 3 that are not in contact with a medium. The measurement electrodes 17, 18 are generally arranged diametrically and form an electrode axis or are intersected by a transverse axis which runs perpendicularly to the magnetic field lines and the longitudinal axis of the measuring tube 2. However, what is also known are devices 8 for tapping off the induced measurement voltage which have more than two measurement electrodes. The flow-rate-dependent measured variable can be determined on the basis of the measured measurement voltage. The flow-rate-dependent measured variable comprises the flow rate, the volume flow, and/or the mass flow of the medium. A measuring circuit 8 is configured to detect the induced measurement voltage applied to the measurement electrodes 17, 18, and an evaluation circuit 24 is designed to determine the flow-rate-dependent measured variable. Magnetic-inductive flow meters with temperature sensors 26 are known. They can be arranged in a lateral opening or integrated in one of the electrodes.

The carrier tube 3 is often formed from an electrically conductive material such as steel. In order to prevent the measurement voltage applied to the first and second measurement electrodes 2, 3 from being conducted away via the carrier tube 3, the inner wall is lined with an insulating material, for example a (plastic) liner 4.

Commercially available magnetic-inductive flow meters have two further electrodes 19, 20 in addition to measurement electrodes 17, 18. For one thing, a fill-level monitoring electrode 19 attached ideally at the highest point in the measuring tube 2 serves to detect partial filling of the measuring tube 1 and is configured to pass this information to the user and/or to take into account the fill level when determining the volume flow. Furthermore, a reference electrode 20, which is usually attached diametrically to the fill-level monitoring electrode 19 or at the lowest point of the measuring tube cross-section, serves to establish a controlled electric potential in the medium. Generally, the reference electrode 20 is used to connect the flowing medium to a ground potential.

The operating circuit 7, control circuit 10, measuring circuit 23, diagnostic circuit 13, and evaluation circuit 24 can be part of a single electronic circuit or can form individual circuits. At least the control circuit 10 has a microprocessor, in particular a programmable microprocessor, i.e., a processor designed as an integrated circuit, which is configured to adjust the voltages and the duration of the time subintervals and to change them so that the specification for the control function is fulfilled. The diagnostic circuit 13 is configured to monitor individual, multiple or interlinked operating signal parameters. Monitoring can be carried out by comparison with nominal values or with tolerance ranges.

The operating circuit 7 is configured to apply a first (coil) voltage to the device 5 for generating the magnetic field for a first time subinterval. According to an advantageous embodiment, the time intervals also each have a second time subinterval in which a, in particular constant, second (coil) voltage second voltage is applied to the device 5 for generating the magnetic field over the, in particular entire, second time subinterval, also a second (coil) voltage to apply to the coil arrangement for a second time subinterval. The second (coil) voltage is greater than the first (coil) voltage. In addition, in a single time interval, the first time subinterval follows the second time subinterval. The duration of the first time subinterval is greater than the duration of the second time subinterval. The duration of the second time subinterval is a controllable variable. So is the first (coil) voltage. FIGS. 2 and 5 show possible embodiments of the operating signal.

In accordance with the invention, the control circuit 10 is configured to control one of the operating signal parameters of the operating signal, in particular at least the first (coil) voltage (U_{hold}) such that a deviation of a control function from a predetermined control setpoint value comprising in particular a variable proportional to a magnetic flux is minimal. The control function can depend on a product of the duration of the second time subinterval and a function dependent on the first (coil) voltage. For this purpose, the first (coil) voltage and the duration of the second time subinterval are controlled such that a variable dependent on the first (coil) voltage and on the duration of the second time subinterval does not deviate from the control target value. In case of a deviation, due to magnetic interference fields or temperature influences, the two control parameters are adjusted until the deviation of the product from the control target value is minimal again.

FIG. 2 shows a first embodiment of the operating signal and the correspondingly produced magnetic field through the coil. According to the invention, the operating signal comprises a (coil) voltage with a time-variable curve 12 which is divided into time intervals t. The sign of the applied (coil) voltage changes in successive time intervals t. The operating signal shown in FIG. 2 comprises time intervals t, each of which has a first time subinterval t_{hold}, in which a constant first (coil) voltage U_{hold} is applied to the coil over the totality of the first time subinterval t_{hold}. The detected measurement voltage induced for determining the flow-rate-dependent measured variable is determined in the first time subinterval t_{hold}, in particular during a measurement interval. During the measurement interval, a coil current flows through the device 5 for generating the magnetic field. This is not constantly regulated, i.e. an absolute value of a measuring (coil) current flowing during the measuring interval at different time intervals t is a variable quantity. According to the first embodiment, the control circuit 10 is configured to control the first (coil) voltage U_{hold} of a time interval t such that a deviation of a control function from a predefined control target value, in particular a control target value comprising a variable that is proportional to a magnetic flux, is minimal. According to the invention, the first (coil) voltage U_{hold} is a time-varying and controllable variable. The rise of the coil current is characterized by a duration of a time subinterval tᵣᵢₛₑ, which can be determined via a measuring circuit. An absolute value of the (coil) current increases within the time subinterval tᵣᵢₛₑ from a first coil current setpoint to a second coil current setpoint.

The first (coil) voltage U_{hold} is controlled such that a variable dependent on the product of the duration of the time subinterval tᵣᵢₛₑ and the first (coil) voltage U_{hold} does not deviate from a predefined second target value.

FIG. 3 shows a time curve of the (coil) current resulting from the voltage signal in FIG. 2. The direction of the (coil) current changes after switching the applied (coil) voltage. Within a rise time subinterval tᵣᵢₛₑ, the absolute value of the (coil) current rises with a non-linear behavior. The (coil) current approaches a maximum coil current value Iₘₐₓ. When the coil current is maximum and substantially no longer changes, the measuring interval tₘₑₛₛ begins. Only measurement voltages determined in this time interval are included in the determination of the flow-rate-dependent variable.

FIG. 4 shows a second embodiment of the operating signal and the produced magnetic field through the device for generating the magnetic field. According to the invention, the operating signal comprises a (coil) voltage with a time-variable curve 12 which is divided into time intervals t. The sign of the applied (coil) voltage changes in successive time intervals t. The operating signal shown in FIG. 4 comprises time intervals t, each having a first time subinterval t_{hold} in which a constant first (coil) voltage U_{hold} is applied to the coil over the entire duration of the first time subinterval t_{hold}. The detected measurement voltage induced for determining the flow-rate-dependent measured variable is determined in the first time subinterval t_{hold}. In addition, the time intervals t each have a second time subinterval tₛₕₒₜ in which a second (coil) voltage Uₛₕₒₜ that is, in particular, constant over the entire duration of the second time subinterval tₛₕₒₜ is applied to the coil. The second (coil) voltage Uₛₕₒₜ is greater than the first (coil) voltage U_{hold}. The first time subinterval t_{hold} follows the second time subinterval tₛₕₒₜ in the voltage curve. In addition, the duration of the second time subinterval tₛₕₒₜ is less than the duration of the first time subinterval t_{hold}. The duration of the second time subinterval tₛₕₒₜ is time-varying and controllable. The same applies to the first (coil) voltage U_{hold}. At least the first (coil) voltage U_{hold} is controlled such that a deviation of a control function from a predefined control target value, in particular a control target value comprising a variable that is proportional to a magnetic flux, is minimal. The control function depends on a product of the duration of the second time subinterval tₛₕₒₜ and a function dependent on the first (coil) voltage U_{hold}. The control target value can be predefined for the entire voltage curve and hence for all time intervals. Alternatively, time intervals with a positive sign in the voltage curve can have a first control target value, and time intervals with a negative sign can have a second control target value, wherein the first control target value differs from the second control target value.

The first (coil) voltage U_{hold} and the second (coil) voltage Uₛₕₒₜ can be set in such a manner that a ratio between the first (coil) voltage U_{hold} and the second (coil) voltage Uₛₕₒₜ is constant over the totality of the voltage curve 12, or an absolute value of a quotient of the first (coil) voltage U_{hold} and the second (coil) voltage Uₛₕₒₜ is constant over the voltage curve 12. This means that when controlling the first (coil) voltage U_{hold}, the second (coil) voltage Uₛₕₒₜ is also automatically adjusted proportional to change. In this case, the function dependent on the first (coil) voltage U_{hold} is preferably inversely proportional to the duration of the second time subinterval tₛₕₒₜ. Alternatively, the second (coil) voltage Uₛₕₒₜ, or an absolute value of the second (coil) voltage Uₛₕₒₜ, can assume a constant value over the entire voltage curve 12.

In addition to controlling the first (coil) voltage U_{hold}, the duration of the second time subinterval tₛₕₒₜ is controlled such that a determined value of a variable dependent on a test variable assumes a test target value within the duration of the second time subinterval tₛₕₒₜ. An example of such an implementation is disclosed in WO 2014/001026 A1. The variable can be, for example, a coil current setpoint value, a sum or an integral of the measured values of the test variable for a predefined time segment. The two control parameters are controlled such that a function dependent on the product of the first (coil) voltage U_{hold} and the duration of the second time subinterval tₛₕₒₜ does not deviate from a predefined second control target value. The function dependent on the first (coil) voltage U_{hold} is inversely proportional to the duration of the second time subinterval tₛₕₒₜ. The test variable may be a measured value of the (coil) current, a time curve of a (coil) current, and/or a variable dependent thereon.

The control circuit is configured to, if a coil test current value or a test variable dependent on the coil test current value differs from a target value in a time interval t_{N}, change the duration of the second time subinterval tₛₕₒₜ such that the difference is smaller in a temporally subsequent time interval t_{N+M}, where M≥1. The control circuit is also configured to, if the actual value differs from a target value in a time interval t_{N}, change the first (coil) voltage U_{hold} such that the deviation from a target value is smaller in a temporally subsequent time interval t_{N+M}, where M≥1. However, at least one of the conditions listed above must be met. The controller circuit can be configured to control further variables and/or functions.

The control function, in particular the function dependent on the first (coil) voltage U_{hold}, can also depend on in ((Uₛₕₒₜ+U_{hold})/(Uₛₕₒₜ−U_{hold})) or be proportional thereto.

FIG. 5 shows a time curve of the (coil) current through the device for generating the magnetic field, in particular through the coil arrangement, resulting from the voltage signal in FIG. 4. The coil current changes the direction of flow in the individual time intervals. By applying the second coil voltage, which is many times higher than the first (coil) voltage, the coil current increases rapidly. From the beginning of the first time subinterval, the coil current continues to increase until it reaches the maximum coil current value Iₘₐₓ. The eddy currents are substantially constant in this time subinterval. The coil current then decreases and converges towards a substantially constant coil current value I_{hold}

In accordance with a further embodiment, a measuring circuit is configured to determine a maximum coil current value Iₘₐₓ in the first time subinterval t_{hold} and to control the duration of the second time subinterval tₛₕₒₜ and the function dependent on the first (coil) voltage U_{hold} in such a manner that a control function does not deviate from a predetermined second nominal value, wherein the control function depends on a product of the duration of the second time subinterval tₛₕₒₜ and the function dependent on the first (coil) voltage U_{hold} and the maximum coil current value Iₘₐₓ.

Alternatively, the control circuit can be configured to control at least one of the operating signal parameters—preferably the first (rinse) voltage U_{hold}—such that one of a quotient of the maximum coil current value Iₘₐₓ, that a coil current value I_{hold} determined by a quotient of the maximum coil current value Iₘₐₓ and a coil current value t_{hold} determined during the first time subinterval is constant over the operating signal.

According to one embodiment, the control function can depend on a product of the duration of a third time subinterval t_{Imax} and a function dependent on the first (coil) voltage U_{hold}. The third time subinterval t_{Imax} is limited by the start of the second time subinterval tₛₕₒₜ and a point in time at which the coil current assumes the maximum coil current value Iₘₐₓ.

The curves shown in FIG. 2 to FIG. 5 are highly simplified schemes. The magnetic field settles generally after the second time subinterval.

The measuring principle on which the invention is based is first explained using the perspective and partially sectioned representation in FIG. 6. A flow measuring probe 101 comprises a generally circular cylindrical housing 102 having a predefined outer diameter. Said housing is adapted to the diameter of a bore, which is located in a wall of a tube line (not shown in FIG. 6) into which the flow measuring probe 101 is inserted in a fluid-tight manner. A medium to be measured flows in the tube line, and the flow measuring probe 101 is immersed into said medium practically perpendicularly to the flow direction of the medium, which is indicated by the wavy arrows 118. A front end 116 of the housing 102 that projects into the medium is sealed in a fluid-tight manner with a front body 115 made of insulating material. By means of a coil arrangement 106 arranged in the housing 102, a magnetic field 109 that extends through the end portion into the medium can be produced. A coil core 111, which at least partially consists of a soft magnetic material and is arranged in the housing 102, terminates at or near the end portion 116. A field return body 114 that surrounds the coil arrangement 106 and the coil core 111 is configured to return, into the housing 102, the magnetic field 109 extending through from the end portion. The coil core 111, the pole shoe 112 and the field return body 114 are each field-conducting bodies 110, which together form a field-conducting arrangement 105. A first and a second measurement electrodes 103, 104 forming a galvanic contact with the medium to be conducted form the device for detecting a measurement voltage induced in the medium and are arranged in the front body 115 and, like the outer walls of the housing, touch the medium. An electrical (coil) voltage induced due to Faraday's law of induction can be tapped off at the measurement electrodes 103, 104 by means of a measurement and/or evaluation unit. It is at a maximum if the flow measuring probe 101 is installed in the tube line such that a plane spanned by a straight line intersecting the two measurement electrodes 103, 104 and by a longitudinal axis of the flow measuring probe runs perpendicularly to the flow direction 118 or to the longitudinal axis of the tube line. An operating circuit 107 is electrically connected to the coil arrangement 106, in particular to the coil 113, and is configured to impress a clocked operating signal to the coil 113 in order to thus produce a clocked magnetic field 109. The control circuit 120 is configured to control at least one of the operating signal parameters of the operating signal, in particular the first (coil) voltage and preferably also the duration of the second time subinterval, such that a deviation of a control function from a predefined control target value, in particular a control target value comprising a variable that is proportional to a magnetic flux, is minimal. For this purpose, according to an advantageous embodiment, the function dependent on the first (coil) voltage U_{hold} and the duration of the second time subinterval tₛₕₒₜ are controlled such that both are inversely proportional to each other.

FIG. 7 shows a representation of one embodiment of the method sequence according to the invention. The method comprises the following method steps:
applying an operating signal having a variable (coil) voltage and a variable (coil) current to the device for generating the magnetic field for feeding electrical power into the device (5) for generating the magnetic field.

The operating signal has a voltage curve that varies over time and is divided into time intervals. These each have a first time subinterval t_{hold}, in which a first (coil) voltage U_{hold} is applied to the coil device over the, in particular totality, of the first time subinterval t_{hold}, in particular constant voltage U_{hold}.

In a further embodiment, the operating signal can be designed as shown in FIGS. 4 and 5 and the associated description of the figures.
controlling the first (coil) voltage U_{hold} in such a way that a difference between a control function and the control setpoint value is minimal.
detecting a (coil) current value serving as a diagnostic value during a measuring interval (tₘₑₛₛ).
monitoring the diagnostic value by comparing the (coil) current value with a factory-provided (coil) current value.

Alternatively, the diagnostic value may comprise the first (coil) voltage (U_{hold}) or the second (coil) voltage (Uₛₕₒₜ) or a variable dependent on the first (coil) voltage (U_{hold}) and/or the second (coil) voltage (Uₛₕₒₜ). In this case, it is not necessary to determine the (coil) current.

Alternatively, the diagnostic value can comprise the duration of the second time subinterval (tₛₕₒₜ) or a variable dependent on the duration of the second time subinterval (tₛₕₒₜ). This is particularly advantageous if the operating circuit is suitable for achieving an exact temporal resolution of the individual durations.

Another alternative is provided by monitoring a quotient of the second (coil) voltage (Uₛₕₒₜ) and the first (coil) voltage (U_{hold}) or the second (coil) voltage (Uₛₕₒₜ) of a subsequent time interval (t). This configuration is advantageous, for example, if the second (coil) voltage is a variable variable and is not linked to the first (coil) voltage via a factor.

Alternatively, the diagnostic value comprises a quotient of two, particularly maximum, (coil) current values determined during different measurement intervals (tₘₑₛₛ). Asymmetries that can be derived from this indicate damage to a single coil out of a plurality of coils.

Alternatively, the diagnostic value comprises a quotient of a (coil) current value determined during the measurement interval (tₘₑₛₛ) and a maximum (coil) current value determined during the time interval (t), particularly during the first time subinterval (t_{hold}).

Alternatively, the diagnostic value comprises a rate of change of the (coil) current over several time intervals (t), particularly several measurement intervals (tₘₑₛₛ).

Alternatively, the diagnostic value comprises a rate of change of the first (coil) voltage (U_{hold}) and/or the second (coil) voltage (Uₛₕₒₜ) over several time intervals (t), particularly several measurement intervals (tₘₑₛₛ).

Alternatively, the following method step is included in the monitoring:
considering a coil resistance of the coil arrangement for monitoring ageing of the coil arrangement.

Alternatively, the diagnostic value of the duration of the second time subinterval (tₛₕₒₜ) or a quantity dependent thereon corresponds to a quotient of two durations, particularly successive, second time subintervals (tₛₕₒₜ).

Alternatively, the diagnostic value of the first (coil) voltage (U_{hold}) or a variable dependent on it corresponds to a quotient of two, particularly successive, first (coil) voltages (U_{hold}).

1-41. (canceled)

42. A magnetic-inductive flow meter for detecting a flow velocity-dependent measurement variable of a flowable medium, the flow meter comprising:
a device configured to generate a magnetic field, which includes a coil arrangement;
a device configured to tap a measuring voltage induced in the flowable medium, which includes at least two diametrically arranged measuring electrodes;
an operating circuit configured to supply electrical power to the magnetic field-generating device by an electrical operating signal including a variable coil voltage and a variable coil current,
wherein the operating signal has a time-varying coil voltage curve, which is divided into time intervals,
wherein the time intervals each have a first time subinterval in which a first voltage of the variable coil voltage is applied to the magnetic field-generating device over the first time subinterval, wherein the first voltage is a constant voltage;
a control circuit configured to control at least the first voltage such that a deviation of a control function from a predetermined control setpoint is minimal, wherein the control setpoint includes a quantity proportional to a magnetic flux; and
a diagnostic circuit configured to monitor at least one diagnostic value.

43. The magnetic-inductive flow meter according to claim 42, wherein the time intervals each have a second time subinterval in which a second voltage, which is constant, is applied to the magnetic field-generating device over the, particularly totality, second time subinterval,
wherein the second voltage is greater than the first voltage,
wherein a duration of the second time subinterval and the first voltage are each a changing and controllable variable,
wherein the control function depends on a product of the duration of the second time subinterval and a function dependent on the first voltage.

44. The magnetic-inductive flow meter according to claim 43, wherein an amount of a quotient of the first voltage and the second voltage is constant over the coil voltage curve, and
wherein the function dependent on the first voltage is inversely proportional to the duration of the second time subinterval.

45. The magnetic-inductive flow meter according to claim 43, wherein a magnitude of the second voltage is constant over the time intervals.

46. The magnetic-inductive flow meter according to claim 42, wherein the coil current assumes a maximum current value in each of the time intervals, particularly in the first time subinterval,
wherein a condition is met that a coil current value determined by a quotient of the maximum current value and a coil current value determined during the first time subinterval is constant over the operating signal.

47. The magnetic-inductive flow meter according to claim 43, wherein the coil current assumes a maximum current value in each of the time intervals, particularly in the first time subinterval,
wherein the function dependent on the first voltage also depends on the maximum current value.

48. The magnetic-inductive flow meter according to claim 43, wherein the function dependent on the first voltage also depends on a function, ln((Uₛₕₒₜ+U_{hold})/(Uₛₕₒₜ−U_{hold}),
wherein Uₛₕₒₜ is the first voltage and U_{hold} is the second voltage.

49. The magnetic-inductive flow meter according to claim 42,
wherein the control function depends on a product of a duration of a time subinterval and a function dependent on the first voltage, and
wherein an amount of coil current increases within the time subinterval from a first current setpoint value to a second current setpoint value.

50. The magnetic-inductive flow meter according to claim 42, wherein the coil current assumes a maximum current value in each of the time intervals, particularly in the first time subinterval,
wherein the control function depends on a product of a duration of a third time subinterval and a function dependent on the first coil voltage,
wherein the third time subinterval is defined by a start of the second time subinterval and a point in time at which the coil current assumes the maximum current value.

51. The magnetic-inductive flow meter according to claim 42, wherein a sign of the coil voltage curve alternates in successive time intervals.

52. The magnetic-inductive flow meter according to claim 51, wherein time intervals with a positive sign in the coil voltage curve have a first control setpoint value and time intervals with a negative sign have a second control setpoint value,
wherein the first control setpoint differs from the second control setpoint.

53. The magnetic-inductive flow meter according to claim 42, wherein the control function depends on a product of a current value of the coil current during a measurement interval and an apparent self-inductance.

54. The magnetic-inductive flow meter according to claim 42, further comprising a device configured to detect the coil current and to determine a current value of the coil current during a measurement interval,
wherein the diagnostic value comprises the coil current value.

55. The magnetic-inductive flow meter according to claim 54, wherein the diagnostic circuit is configured to compare the coil current value with a factory-provided coil current value.

56. The magnetic-inductive flow meter according to claim 54, wherein the coil current value corresponds to a maximum current value present during a time interval or during the first time subinterval and/or second time subinterval.

57. The magnetic-inductive flow meter according to claim 42, wherein the diagnostic value comprises the first voltage or the second voltage or a quantity dependent on the first voltage and/or the second voltage.

58. The magnetic-inductive flow meter according to claim 42, wherein the diagnostic value comprises a duration of the second time subinterval or a variable dependent on the duration of the second time subinterval.

59. The magnetic-inductive flow meter according to claim 42, wherein the diagnostic value comprises a quotient of the second voltage and the first voltage or the second voltage of a subsequent time interval.

60. The magnetic-inductive flow meter according to claim 42, wherein the diagnostic value comprises a quotient of two maximum current values determined during different measurement intervals.

61. The magnetic-inductive flow meter according to claim 42, wherein the diagnostic value comprises a quotient of a coil current value determined during a measurement interval and a maximum current value determined during the first time subinterval.

62. The magnetic-inductive flow meter according to claim 42, wherein the diagnostic value comprises a rate of change of the coil current over several time intervals, particularly several measurement intervals.

63. The magnetic-inductive flow meter according to claim 42, wherein the diagnostic value comprises a rate of change of the first voltage and/or the second voltage over several time intervals, particularly several measurement intervals.

64. The magnetic-inductive flow meter according to claim 42, wherein for monitoring ageing of the magnetic field-generating device, particularly the coil arrangement, the diagnostic circuit is configured to take into account a coil resistance of the coil arrangement.

65. The magnetic-inductive flow meter according to claim 43, wherein the diagnostic value of the duration of the second time subinterval or a variable dependent thereon corresponds to a quotient of two durations, particularly successive, second time subintervals.

66. The magnetic-inductive flow meter according to claim 42, wherein the diagnostic value of the first voltage or a variable dependent thereon corresponds to a quotient of two, particularly successive, first voltages.

67. The magnetic-inductive flow meter according to claim 42, further comprising a temperature sensor configured to detect a first temperature value,
wherein the diagnostic circuit is configured to determine a second temperature value as a function of a coil current value and a known temperature coefficient,
wherein the diagnostic circuit is configured to compare the first temperature value to the second temperature value so as to monitor ageing of the magnetic field-generating device.

68. A method for operating a magnetic-inductive flow meter for determining a flow rate-dependent measured variable of a flowable medium, wherein the magnetic-inductive flow meter comprises a device configured to generate a magnetic field and a device configured to tap a measurement voltage in the medium, the method comprising:
applying an electrical operating signal including a variable coil voltage and a variable coil current to the magnetic field-generating device, which operating signal supplies electrical power to the magnetic field-generating device,
wherein the operating signal has a time-varying coil voltage curve, which is divided into time intervals,
wherein the time intervals each have a first time subinterval, in which a first voltage is applied to the magnetic field-generating device over the first time subinterval, and
wherein the first voltage is controlled such that a deviation of a control function from the control setpoint is minimized; and
monitoring a diagnostic value.

69. The method according to claim 68, further comprising:
detecting a coil current value, wherein the coil current value is determined during a measurement interval, and
wherein the diagnostic value comprises the coil current value.

70. The method according to claim 28, further comprising:
comparing the coil current value with a factory-provided current value.

71. The method according to claim 68, wherein the coil current value corresponds to a maximum current value present during a time interval or during the first time subinterval and/or a second time subinterval.

72. The method according to claim 68, wherein the diagnostic value comprises the first voltage or a second voltage or a quantity dependent on the first voltage and/or the second voltage.

73. The method according to claim 68, wherein the diagnostic value comprises a duration of a second time subinterval or a variable dependent on the duration of the second time subinterval.

74. The method according to claim 68, wherein the diagnostic value comprises a quotient of a second voltage and the first voltage or the second voltage of a subsequent time interval.

75. The method according to claim 68, wherein the diagnostic value comprises a quotient of two, particularly maximum, coil current values determined during different measurement intervals.

76. The method according to claim 68, wherein the diagnostic value comprises a quotient of a coil current value determined during a measurement interval and a maximum current value determined during the time interval, particularly during the first time subinterval.

77. The method according to claim 68, wherein the diagnostic value comprises a rate of change of the coil current over several time intervals, particularly several measurement intervals.

78. The method according to claim 68, wherein the diagnostic value comprises a rate of change of the first voltage and/or a second voltage over several time intervals, particularly several measurement intervals.

79. The method according to claim 68, further comprising:
taking account of a coil resistance of a coil arrangement of the magnetic field-generating device for monitoring ageing of the magnetic field-generating device.

80. The method according to claim 68, wherein the diagnostic value of a duration of a second time subinterval or a variable dependent thereon corresponds to a quotient of two durations, particularly successive, second time subintervals.

81. The method according to claim 68, wherein the diagnostic value of the first voltage or a variable dependent thereon corresponds to a quotient of two, particularly successive, first voltages.

82. The method according to claim 68, further comprising:
determining a first temperature value using a temperature sensor; and
detecting a second temperature value as a function of a coil current value and a known temperature coefficient,
wherein the diagnostic circuit is configured to compare the first temperature value with the second temperature value so as to monitor ageing of the magnetic field-generating device.
